(19) United States
(12) Patent Application Publication
(10) Pub. No.: US 2007/0215371 A1
(43) Pub. Date: Sep. 20, 2007

(54) Dampening Apparatus

(76) Inventor: Stewart James Wright, Queensland (AU)

Correspondence Address: Martin P Hoffman;Hoffman Wasson & Gitler, 2461 South Clark Street, Suite 522, Arlington, VA, 22202, US

(21) Appl. No.: 10/576,950

(22) PCT Filed: Oct. 22, 2004
(86) PCT No.: PCT/AU04/01463

§ 371 Date: Feb. 9, 2007

(30) Foreign Application Priority Data
Oct. 22, 2003 (AU) 2003905795

(51) Int. Cl. E21B 7/00; F16F 11/00

(52) U.S. Cl. 173/185; 248/638

(57) ABSTRACT

A support structure for a tool comprising a boom or arm for supporting the tool, a pendulum pivot supporting the tool with respect to the boom or arm in a manner which allows the tool to pendulate and self monitoring and operating dampening means for controlling the pendulation of the tool on the pendulum pivot with respect to the boom or arm.

### TECHNICAL FIELD

This invention relates to dampening apparatus and has particular relevance to apparatus used for dampening or otherwise controlling the movements of elements of equipment and machinery.

### BACKGROUND ART

Agricultural and construction equipment and machinery is often used in situations where the personal safety of operators and others within the vicinity of the machinery is of primary importance.

Many types of machinery such as that used for drilling, digging, cutting and the like a tool is suspended from a boom arm or other form of support.

Rotatable auger devices or examples are generally suspended from booms and engineered so that the auger can be set up to drill vertical holes in required positions despite the fact that the surrounding terrain may mean that the vehicle to which the device is attached is not on a level surface.

To accommodate various types of terrains and conditions the augers are normally suspended so that they are able to freely swing on intersecting planes.

When drilling is not taking place and the vehicle or boom arm is being moved, the augers can pendulate in a largely uncontrolled manner creating a particularly dangerous potential impact situation for the operator and persons or property nearby.

Drilling augers are not the only types of equipment where tools are able to pendulate in a dangerous manner, other examples being pile drivers, mowing, lifting, cutting and digging equipment.

International patent application no. PCT/AU02/00295 describes a support structure for a tool incorporating self-monitoring and operating dampening means for controlling the pendulation of a tool with respect to a boom or arm. Whilst the apparatus described has been warmly welcomed by users for its obvious safety advantages in some instances, particularly involving larger machinery, the dampening means needs to be beefed up to the extent that in some user situations it is obtrusive.

It is an object of the present invention to provide a compact support structure for a tool where pendulation of the tool with respect to a supporting device is controlled and/or inhibited.

Further objects and advantages of the present invention will become apparent from the ensuing description which is given by way of example.

### DISCLOSURE OF INVENTION

According to the present invention, there is provided a support structure for a tool comprising

(a) a boom or arm for supporting the tool,

(b) a pendulum pivot supporting the tool with respect to the boom or arm in a manner which allows the tool to pendulate,

(c) self monitoring and operating dampening means for controlling the pendulation of the tool on the pendulum pivot with respect to the boom or arm.

The support structure may include a boom, a first pivoted link supporting the tool from the boom and enabling it to swing in a first plane and a second pivoted link on a second plane at right angles to the first plane, and dampening means for controlling the pivoting of the tool relative to the boom in either plane.

The first pivoted link may be provided by a frame having two spaced lugs joined by a cross member, the lugs being pivotably connected to a yoke which provides a second pivotal link with the tool, said second pivotal link comprising a frame extending from the tool which is pivotably connected to said pair of spaced plates, said dampening means being connected to the pivot connections and being adapted to dampen pivoting on the pivot axis.

The dampening means may be rotary hydraulic actuators wherein pivot connections of the pendulum pivot are coupled to a rotor of the rotary hydraulic actuators.

The dampening means comprising rotary hydraulic actuators preferably includes a rotary hydraulic actuator coupled to each pivot connection of the dampening means. It will be appreciated that the dampening means may include rotary hydraulic actuators coupled to selected pivot connections if dampening is required in a selected plane. Similarly, rotary hydraulic actuators may be provided with varying degrees of dampening whereby the tool may be clamped preferentially in selected planes through selected pivots.

Rotary hydraulic actuators use pressurized hydraulic fluid, such as oil to rotate mechanical components. The flow of pressurized hydraulic fluid produces the rotation of moving components via a rack and pinion, cams, direct air/fluid pressure on rotary vanes, or other mechanical linkage. In the present invention the rotary hydraulic actuators are sealed and include a closed-loop of hydraulic fluid that serves to dampen the rotation of the pivots.

The pivot connection may be in the form of a rotor that extends through the pivoted link and into the housing of the rotary hydraulic actuator.

The hydraulic rotary actuators are capable of providing variable dampening resistance depending on specific requirements.

The varying dampening resistance may be provided internally and/or externally of the rotary hydraulic actuators.

The varying dampening resistance of the rotary hydraulic actuators may be provided by a provision of grooves or flutes in the rotor housing, rotor, or end plate of the motor, and/or in the pivoted connection.

The grooves or flutes may be peripheral and extend partially throughout peripheral surfaces of the rotary actuator components.

The grooves or flutes may vary in cross-sectional area According to the present invention, there is provided a method of dampening using a hydraulic rotary actuator the method comprising the steps of:

(a) coupling a rotary hydraulic actuator to a pivot connection, static or rotating element of a device,

(b) adapting the rotary hydraulic actuator to provide varying rotary resistance to the connection, or static or rotary element of the device.

Although the dampening means is described as a “rotary hydraulic actuator”, it will be appreciated from the ensuing description that in the use situation described, the actuators are not used in a conventional manner. Conventionally, an actuator translates power provided by an external source e.g. a pump. The present situation, it is somewhat the reverse of the conventional situation in that there is no external power source and an actuator type apparatus is used to dampen as opposed to translating forces.

### BRIEF DESCRIPTION OF THE DRAWINGS

Aspects of the present invention will now be described with reference to the accompanying drawings in which:

FIG. 1 is a perspective view of a support structure according to the present invention, and

FIGS. 2 and 3 are side views of the structure of FIG. 1, and

FIG. 4 is a sectional drawing taken at IV:IV of FIG. 2, and

FIG. 5 is a sectional drawing of the support structure and a dampening device of the present invention, and

FIGS. 6, 7 and 8 are individual perspective drawings a rotor housing, rotor, and end plate for the dampening device of FIG. 5, and

FIGS. 9, 10 and 11 are diagrammatic illustrations the manner in which the dampening device of FIG. 5 can be engineered to provide minimum and maximum resistance depending on specific requirements.

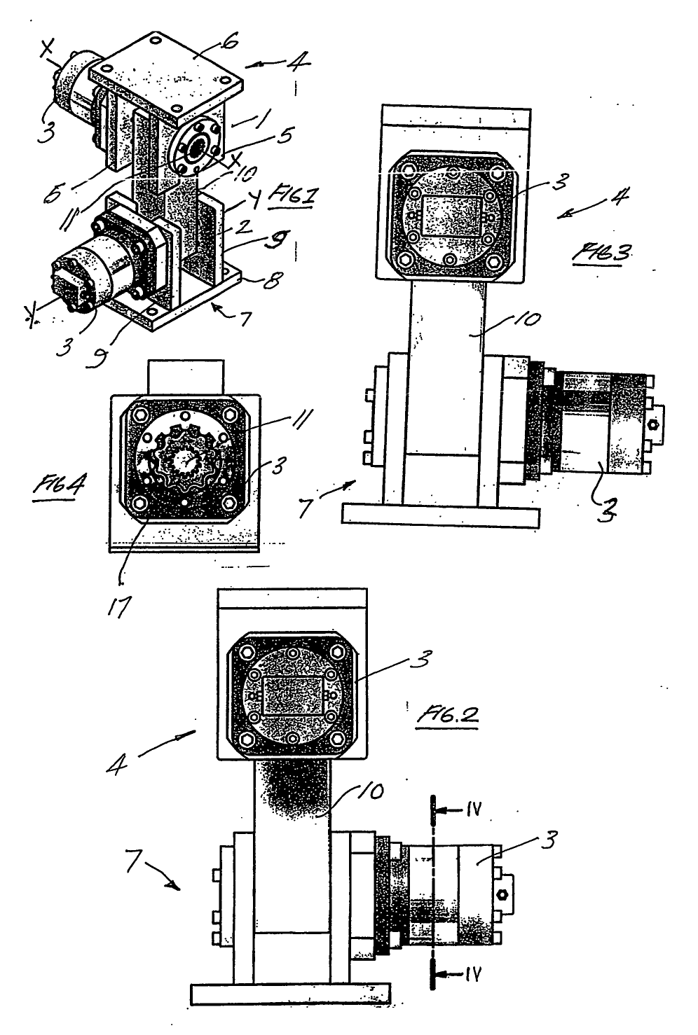

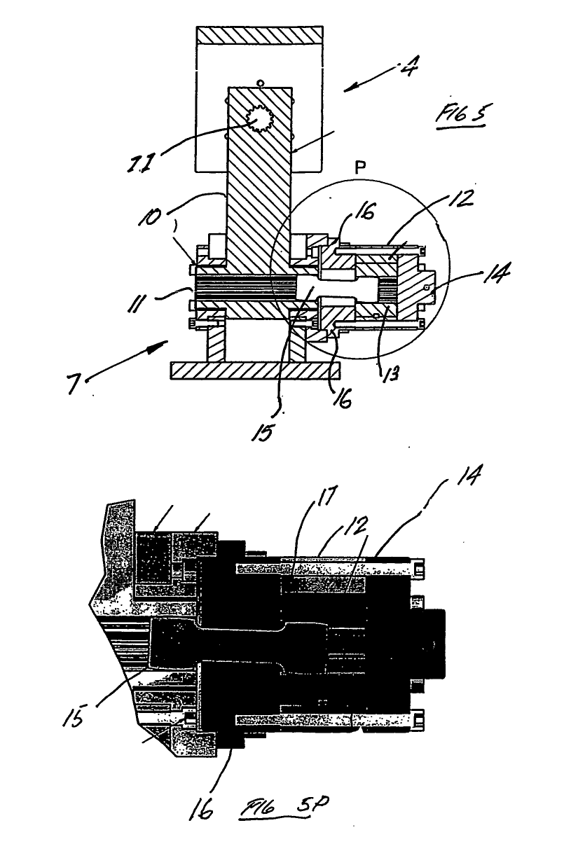

With respect to the drawings, the present invention provides a support structure for supporting a tool (not shown) with respect to a boom or arm (not shown) in a similar manner to that described by international patent application no. PCT/AU02/00295.

The support structure includes a first pivoted link 1 for supporting a tool from a boom and enabling the tool to swing in a first plane X:X and a second pivoted link 2 on a second plane Y:Y at right angles to the first plane.

Dampening means in the form of rotary hydraulic actuators 3 (as herein defined) are provided for controlling the pivoting of a tool relative to a support such as a boom.

The first pivoted link 1 includes a frame generally indicated by arrow 4 having two spaced lugs 5 joined by a cross-member 6.

The second pivoted link 2 includes a similar frame generally indicated by arrow 7 comprising a cross-member 8 and lugs 9.

A yoke 10 is connected between the first and second pivot axis in an arrangement which allows the frames to pivot on the respective axis XX and YY.

The actuators 3 are operatively connected to pivot axles 11, the arrangement being best exemplified by FIGS. 5 and 5P.

The actuators shown to the right of each figure are adaptions of a type of actuator known as rotary hydraulic actuators which can be purchased as off-the-shelf items.

Typically, the actuators include a housing 12, a rotor 13, an end flange 14 and a connecting link 15.

The connecting link 15 connects the rotor 13 via an inner flange 16.

FIGS. 4 and 9 to 11 of the drawings illustrate how the rotors 13 of the actuators are offset in relation to the rotor housings 12 and links 15.

As the rotors rotate relative to the housings, a fluid material (usually oil or grease) within the actuators is forcibly displaced.

In the use situation illustrated, the displacement of the fluids within the actuators creates a resistance and therefore dampening of pivotal movement between the yoke 10 and the frames 4 and 7.

Links 15 ensure that resistances within the motors are directly translated to the yoke.

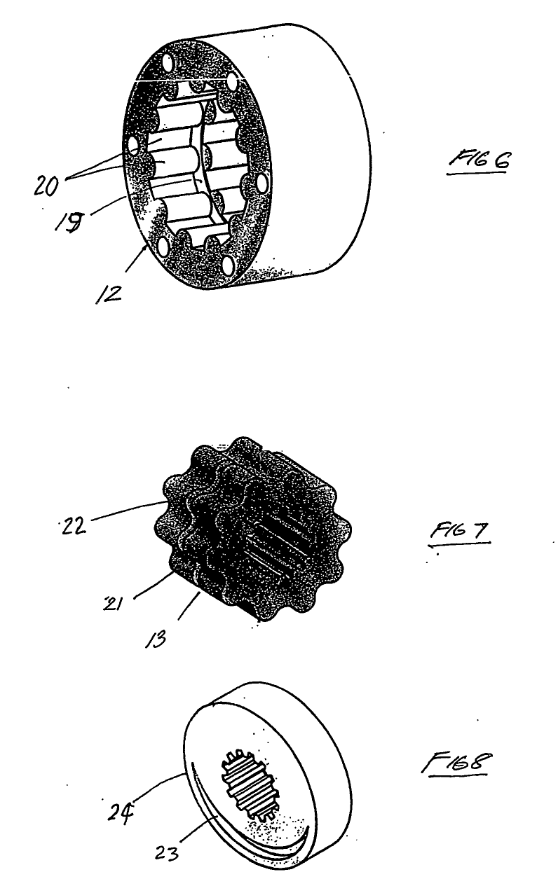

FIGS. 6 to 8 of the drawings illustrate grooves or fluting in the rotor housing, rotor and end plates can be used to achieve variable rotary resistance.

In the rotor housing 12 (FIG. 6), a groove or flute 19 may be provided on the inner face of the housing interrupting the surfaces 20.

In the rotor 13 (FIG. 7), a groove or flute 21 may intercept a portion of the outer surface 22 of the rotor.

In the rotor end plate 14 (FIG. 8), a groove 23 may be provided in the inner wall of the rotor.

The grooves or flutes 19, 21 and 23 are semi-circular and the effect of having the grooves is to increase the volume of the internal chambers of the actuators at predetermined moments of relative rotary motion to thus achieve variable rotary resistance.

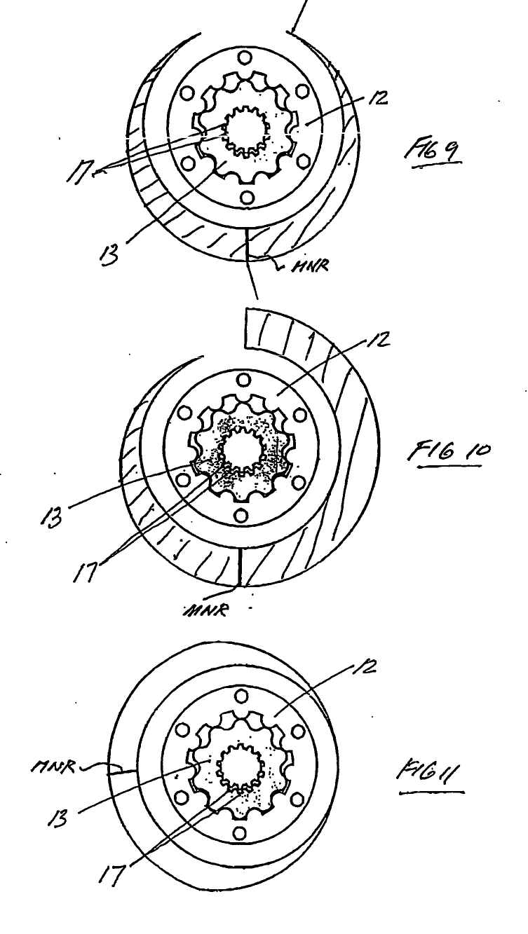

The shaded areas of FIGS. 9 to 11 graphically illustrate the variable rotary resistances showing maximum resistance and minimal resistance MNR depending on the arc of rotations and the relative positions of internal grooved and fluted components.

Dampening between a tool and its support should be the greatest when the tool is in the operative (vertical) position and less as the tool swings towards a horizontal plane. The flutes and grooves 19, 21 and 23 are arranged to gradually increase the volume of the actuator inner housing allowing increased displacement area for the fluids within the housing and by so doing decreased resistance to relative rotary movement between a tool and its support.

Dampening may also be further fine tuned by having an external closed circuit for fluid transfer (not shown) communicable with the interiors of the housing. A flow adjustment valve (not shown) may be positioned in the external closed circuit.

Whilst the structure and methodology of the present invention is primarily directed at dampening the pendulation of suspended tools, it is envisaged that the dampening methodology and apparatus may be used in many situations, for example;

(a) for dampening the pivotal action to gates, doors and other forms of closure,

(b) for dampening the linear motion of wheeled carriages.

Aspects of the present invention have been described by way of example only and it is to be appreciated that modifications and additions thereto may be made without departure from the spirit or scope thereof.

1. A support structure for a tool comprising
(a) a boom or arm for supporting the tool,
(b) a pendulum pivot supporting the tool with respect to the boom or arm in a manner which allows the tool to pendulate,
(c) self monitoring and operating dampening means for controlling the pendulation of the tool on the pendulum pivot with respect to the boom or arm.

2. A support structure for a tool according to claim 1 wherein the pendulum pivot comprises a first pivoted link supporting the tool from the boom and enabling it to swing in a first plane and a second pivoted link on a second plane at right angles to the first plane, and wherein the dampening means controls the pendulation of the tool relative to the boom in either plane.

3. A support structure for a tool according to claim 2 wherein the first pivoted link comprises a frame having two spaced lugs joined by a cross member, the lugs being pivotably connected to a yoke which provides a second pivotal link comprising a frame extending from the tool which is pivotably connected to said pair of spaced plates.

4. A support structure for a tool according to claim 1 wherein the dampening means comprises rotary hydraulic actuators wherein pivot connections of the pendulum pivot are coupled to a rotor of the rotary hydraulic actuators.

5. A support structure for a tool according to claim 4 wherein the dampening means includes a rotary hydraulic actuator coupled to each pivot connection of the dampening means.

6. A support structure for a tool according to claim 4 wherein the rotary hydraulic actuators are sealed and include a closed-loop of hydraulic fluid that serves to dampen the rotation of the pivots.

7. A support structure for a tool according to claim 4 wherein the rotary hydraulic actuators includes grooves or flutes in the rotor housing, rotor, end plate of the motor, and/or in the pivoted connection.

8. A method of dampening using a hydraulic rotary actuator the method comprising the steps of:
(a) coupling a rotary hydraulic actuator to a pivot connection, static or rotating element of a device,
(b) adapting the rotary hydraulic actuator to provide varying rotary resistance to the connection, or static or rotary element of the device.
